(19) United States
(12) Patent Application Publication
(10) Pub. No.: US 2006/0131409 A1
(43) Pub. Date: Jun. 22, 2006

(54) Apparatus for mounting an MSR to a display system at multiple locations

(76) Inventors: Jeffrey Thomas Haller, South San Francisco, CA (US); Ken North, San Carlos, CA (US)

Correspondence Address: Marguerite E. Gerstner, MS R20/2B, 307 Constitution Drive, Menlo Park, CA, 94025-1164, US

(21) Appl. No.: 11/014,434

(22) Filed: Dec. 16, 2004

(51) Int. Cl. G06K 7/08

(52) U.S. Cl. 235/449

(57) ABSTRACT

A magnetic stripe reader (MSR) is configured to be attached to a display system. The MSR has a housing for at least partially enclosing an electronic unit which reads and decodes a magnetic stripe on a transaction card. An arm member extends from the housing. A mount plate is attachable to the arm member and is configured to secure the MSR to the display system. The MSR may be attached to the display system in multiple locations, allowing the position of the MSR to be configurable with respect to a display of the display system.

### BACKGROUND OF THE INVENTION

This invention relates generally to magnetic stripe readers (MSR), and more particularly, to apparatus for mounting an MSR to a display system.

Monitor assemblies and display systems which have an MSR attached are provided for an increasing number of applications. Point of sale (POS), for processing transactions within a department store, and point of information (POI), such as an electronic directory are common. For example, applications include airport passenger and baggage check-in, and kiosks located within a store which provide information about products and services. The kiosks also may be used to place an order and/or complete a purchase without the assistance of a sales person.

The MSR reads a swiped transaction card and transfers the information to the display system. The transaction card may be a credit, debit, or loyalty card, for example. The display system may have a touchscreen or a separate keyboard which allows input from a user. The display system may also have an integrated personal computer (PC). The display system and MSR are often provided as an integrated unit where the MSR is accessed through a slot in the housing of the display system or kiosk structure.

Other monitor/display assemblies and MSR units provide the MSR installed on the right hand side of the display screen, which may interfere with access to other equipment installed in close proximity to the display assembly. Alternatively, the user may attach an external MSR to the display assembly with tape, which does not secure the MSR against theft and/or abuse. As more applications are implemented for the transaction cards and interactive display systems, users desire increasing flexibility regarding the configuration of the display system and the MSR unit.

Therefore, a need exists for alternative and flexible options regarding the placement of the MSR unit with respect to the display system. Certain embodiments of the present invention are intended to meet these needs and other objectives that will become apparent from the description and drawings set forth below.

### BRIEF DESCRIPTION OF THE INVENTION

In one embodiment, a magnetic stripe reader (MSR) is configured to be attached to a display system. The MSR has a housing for at least partially enclosing an electronic unit which reads and decodes a magnetic stripe on a transaction card. An arm member extends from the housing. A mount plate is attachable to the arm member and is configured to secure the MSR to the display system.

In another embodiment, a display system has a magnetic stripe reader (MSR) configured to be mounted to a display system in at least two locations. The display system has a display for presenting information. The display system has a back plate, and a left side and a right side with respect to the display. An MSR comprises a housing retaining an electronic unit for reading a magnetic stripe of a transaction card. The MSR further comprises a mount plate which is connected to the housing. The mount plate is configured to be attached to the back plate to secure the MSR to the display system.

In another embodiment, a display system has a magnetic stripe reader (MSR) securely attached to the display system. The MSR comprises a housing for retaining an electronic unit for reading a magnetic stripe of a transaction card. The housing has a slot for sliding the transaction card through. The MSR further comprises a mount plate being attachable to the housing. A display system comprises a display for displaying information to and accepting input from a user. The display system further comprises a plate being at least partially obscured by a cover. The plate provides at least one mounting location for attaching the mount plate of the MSR to the display system.

### BRIEF DESCRIPTION OF THE DRAWINGS

FIG. 1 illustrates a back view of a display system in accordance with an embodiment of the present invention.

FIG. 2 illustrates the MSR formed in accordance with an embodiment of the present invention.

FIG. 3 illustrates the MSR and a portion of the back cover formed in accordance with an embodiment of the present invention.

FIG. 4 illustrates the MSR being partially installed on the right side of the display system in accordance with an embodiment of the present invention.

FIG. 5 illustrates the MSR installed on the left side and the MSR installed on the right side of the display system in accordance with an embodiment of the present invention.

FIG. 6 illustrates the display system having the removable back cover installed in accordance with an embodiment of the present invention.

FIG. 7 illustrates a front view of the display system having the MSR mounted on the left side in accordance with an embodiment of the present invention.

FIG. 8 illustrates a front view of the display system having the MSR mounted on the right side in accordance with an embodiment of the present invention.

The foregoing summary, as well as the following detailed description of certain embodiments of the present invention, will be better understood when read in conjunction with the appended drawings. It should be understood that the present invention is not limited to the arrangements and instrumentality shown in the attached drawings.

### DETAILED DESCRIPTION OF THE INVENTION

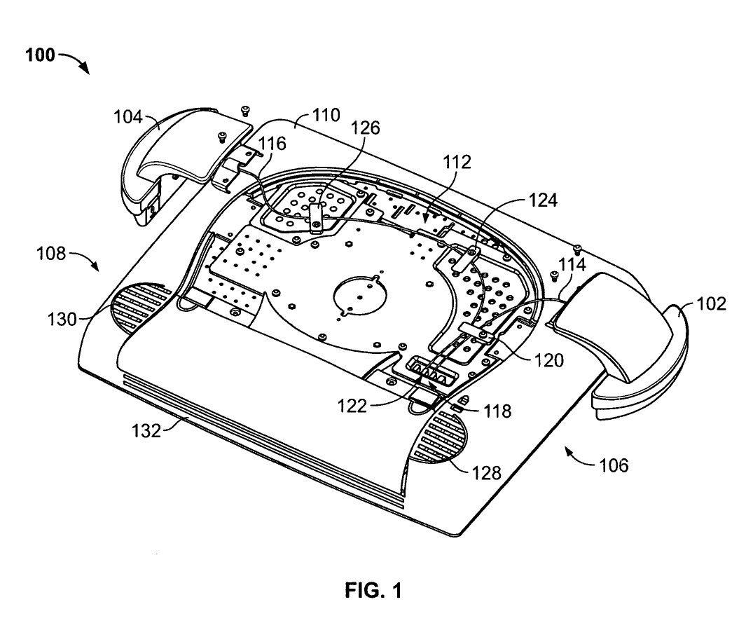

FIG. 1 illustrates a back view of a display system 100 in accordance with an embodiment of the present invention. The display system 100 may be used as a point of sale (POS) terminal in a department or grocery store, for example. The display system 100 is illustrated having a magnetic stripe reader (MSR) 102 being mountable on a left side 106 of the display system 100 and an MSR 104 being mountable on a right side 108 of the display system 100. The left side 106 and right side 108 are oriented with respect to a user's view of a front face or a display screen (not shown) of the display system 100. Although a user may wish to have only a single MSR 102 and 104 installed, the display system 100 provides the flexibility to install an MSR on either the left side 106 or the right side 108.

A back cover 110 is provided with an open center portion 112. The back cover 110 may be formed of molded plastic. Vents 128-132 may be provided in the back cover 110 to allow heat to dissipate from the display system 100. The open center portion 112 allows access to cables 114 and 116. One end of the cable 114 is attached to a connector 118 of the display system 100 and the other end of the cable 114 is attached to an electronic unit (not shown) within the MSR 102. The electronic unit provides the functionality for reading and decoding a magnetic stripe on a transaction card. The cable 114 is routed under and held in place by a clip 120 in the open center portion 112. One end of the cable 116 is attached to a connector 122 of the display system 100 and the other end of the cable 116 is attached to an electronics unit (not shown) within the MSR 104. The cable 116 is routed under and held in place by clips 120, 124, and 126 in the open center portion 112. The cables 114 and 116 may be USB or serial cables, depending upon the type of electronic unit being used.

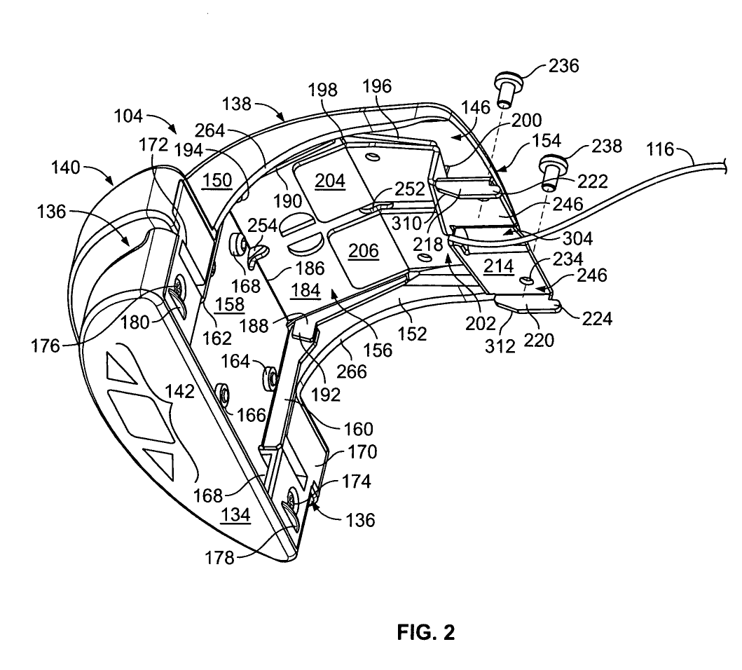

FIG. 2 illustrates the MSR 104 formed in accordance with an embodiment of the present invention. The MSR 104 comprises an arm member 138 and a housing 140. The arm member 138 and the housing 140 may be formed of one piece of molded material, such as molded plastic, or may be formed of more than one piece of material and then joined to one another.

The electronic unit (not shown) capable of reading a transaction card is provided within the housing 140. The housing 140 has a front face 134 which is visible when looking at the front of the display system 100. Indications 142 may be provided on the front face 134 for instructing a user of a proper orientation for holding and swiping a transaction card through a slot 136 provided in the housing 140. The indications 142 may be decals, etchings, paint, and the like.

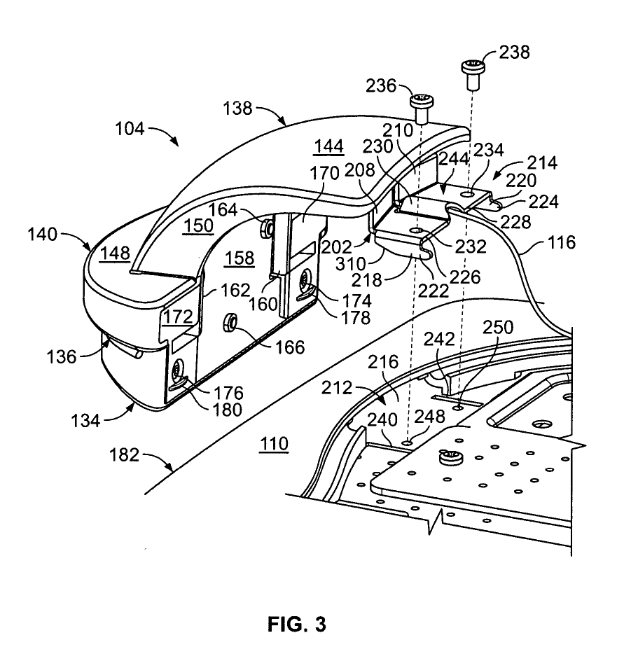

FIG. 3 illustrates the MSR 104 and a portion of the back cover 110 formed in accordance with an embodiment of the present invention. FIGS. 2 and 3 will be discussed together. The arm member 138 comprises an outer surface 144 and an inner surface 146. The arm member 138 is curved to extend from a back side 148 of the housing 140. The arm member 138 comprises side walls 150 and 152 extending from the inner surface 146. The side walls 150 and 152 have edges 264 and 266, respectively. The side walls 150 and 152 decrease in width moving from the back side 148 of the housing towards an outer edge 154 of the arm member 138, minimizing the overall thickness of the arm member 138.

A frame 156 is bent and formed of one piece of sheet material. The frame 156 is attachable to both the housing 140 of the MSR 104 and the display system 100. The frame 156 may comprise a housing portion 158 having side edges 160 and 162. The side edges 160 and 162 are bent and formed to be perpendicular with respect to the housing portion 158. The housing portion 158 may be attached to the housing 140 with one or more fasteners 164-168. The fasteners 164-168 may be one of screws, nuts, and the like. The frame 156 may be removed from the housing 140 to provide access for servicing or replacing the electronic unit.

The housing 140 further comprises back covers 170 and 172. The back covers 170 and 172 may be separate pieces, or may be one piece comprising molded plastic. The housing portion 158 of the frame 156 has integral tabs extending beneath the back covers 170 and 172. Tab 168 is partially illustrated extending beneath the back cover 170. The tab extending beneath back cover 172 is not shown. The back covers 170 and 172 attach the frame 156 to the housing 140 with fasteners 174 and 176. The back covers 170 and 172 may also have protrusions 178 and 180 which provide a stand off from a side edge 182 of the display system 100.

The housing portion 158 of the frame 156 is bent at intersection 186 and formed integral with an intermediate portion 184. Intermediate portion 184 has integral side edges 188 and 190 bent and formed to be substantially perpendicular with respect to the intermediate portion 184. Side edges 188 and 190 of the intermediate portion 184 may overlap side edges 160 and 162, respectively, of the housing portion 158 at overlap areas 192 and 194 which may be fused or spot welded to provide strength and rigidity to the frame 156.

The intermediate portion 184 of the frame 156 is bent at intersection 198 and is integral with an outer end portion 196. The outer end portion 196 forms an obtuse angle with respect to the intermediate portion 184. A ridge 200 is formed integral with the inner surface 146 of the arm member 138, providing a stand off between the inner surface 146 and the outer end portion 196.

A mounting bracket 202 is bent and formed of a single piece of sheet material and is attachable to the frame 156. In FIG. 2, the mounting bracket 202 overlaps portions of, and may be spot welded to, the intermediate portion 184 and the outer end portion 196. Although the mounting bracket 202 and the frame 156 are illustrated as two separate pieces which are joined to one another, it should be understood that the mounting bracket 202 and the frame 156 may be formed of a single piece of material.

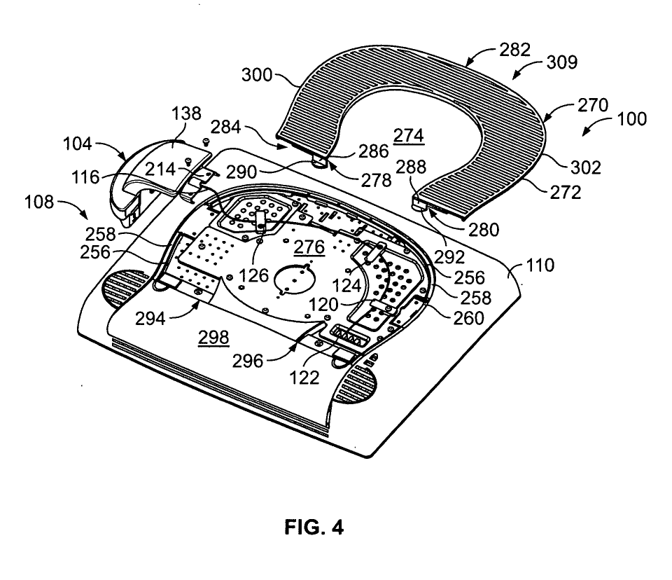

The mounting bracket 202 comprises arms 204 and 206 being bent to form three segments. Two segments of the arms 204 and 206 overlap and are attached to the intermediate portion 184 and the outer end portion 196 as discussed previously. The third segment forms side walls 208 and 210 configured to extend into a cavity 212 formed beneath the back cover 110. The side walls 208 and 210 are configured to have a height sufficient to allow a removable back cover 270 (discussed below with FIG. 4) to fit into a gap created between the inner surface 146 and edges 264 and 266 of the arm member 138 and the back cover 110.

A mount plate 214 is formed integral with the side walls 208 and 210, and is bent to occupy a plane parallel with respect to a back plate 216 within the display system 100. The mount plate 214 has a bottom surface 246 and a top surface 244, which faces the inner surface 146 of the arm member 138. Interlocking members 218 and 220 are bent away from the inner surface 146 of the arm member 138 to be substantially perpendicular to the back plate 216. The interlocking members 218 and 220 have finger portions 222 and 224, respectively, which extend below and beyond front edges 226 and 228 of the mount plate 214. The mount plate 214 has holes 232 and 234 through which fasteners 236 and 238 are extended.

The mount plate 214 is bent to form a curved portion 230 extending upwards towards the inner surface 146 of the arm member 138. A trough 304 is formed beneath the curved portion 230. The cable 116 is placed in the trough 304 between the curved portion 230 and the back plate 216, securing and protecting the cable 116. The cable 116 is routed between the frame 156 and the arm member 138 and interconnected with the electronic unit located within the housing 140. The frame 156 has holes 252 and 254 cut therein which provide relief or additional space for the cable 116, if necessary.

To install the MSR 104 onto the display system 100, the MSR 104 may be tilted such that the finger portions 222 and 224 of the interlocking members 218 and 220, respectively, are inserted first into grooves or slots 240 and 242 provided in the back plate 216. The interlocking members 218 and 220 may have a ramped edge 244 and 246, respectively, at an end opposite the finger portions 222 and 224. The ramped edges 244 and 246 more easily facilitate the installation and removal of the interlocking members 218 and 220 within the slots 240 and 242. When the interlocking members 218 and 220 are fully inserted into the slots 240 and 242, respectively, the bottom surface 246 of the mount plate 214 rests against the back plate 216, and the finger portions 222 and 224 extend underneath the back plate 216. Therefore, the finger portions 222 and 224 help to secure the MSR 104 to the display system 100. The fasteners 236 and 238 are inserted through the holes 232 and 234, respectively, of the mount plate 214 from the top surface 244 towards the back surface 246 as illustrated. The fasteners 236 and 238 are then inserted into holes 248 and 250, respectively, and secured to the back plate 216. The MSR 104 is now securely fastened to the display system 100.

FIG. 4 illustrates the MSR 104 being partially installed on the right side 108 of the display system 100 in accordance with an embodiment of the present invention. The cable 116 has been connected to the connector 122 and routed and secured under clips 120, 124 and 126.

A lip 256 and groove 258 are formed along an inside edge of the back cover 110. Break away plugs 260 and 262 (break away plug 262 is shown in FIG. 6) are formed on each side of the back cover 110 corresponding to locations where the MSR 102 and MSR 104 may be installed. Only break away plug 260 is illustrated in FIG. 4. The break away plug 262 which had been formed on the right side 108 of the display system 100 where the MSR 104 is to be installed has been removed.

The break away plugs 260 and 262 illustrate two locations within the display system 100 where the MSRs 102 and 104 may be installed. It should be understood that the MSRs 102 and 104 may be installed in locations other than those shown by providing other break away plugs and appropriate mounting attachments on the back plate 216. Additionally, break away plugs 260 and 262 may not be used, and instead access to the cavity 212 may be accomplished with other methods such as cutting the back cover 110 or molding the back cover 110 differently.

A removable back cover 270 is illustrated and has a top edge 282, bottom edge 284, and side edges 300 and 302. The removable back cover 270 may be formed of molded plastic or other lightweight material, and may comprise vents 272 to facilitate heat dissipation from within the display system 100. The removable back cover 270 may be substantially U shaped, having an open center area 274. When the removable back cover 270 is installed on the display system 100, the open center area 274 allows access to a stand mount area 276 where a display system stand or monitor stand (not shown) may be attached. A rib (not shown) is integrally formed along a perimeter of the removable back cover 270. The rib extends away from a back surface of the removable back cover 270 and is configured to be received by the groove 258 in the back cover 110. It should be understood that this is one representation of how the removable back cover 270 may be shaped and formed, but that other shapes are envisioned.

Interlocking members 278 and 280 are formed integral with the bottom edge 284 of the removable back cover 270. The interlocking members 278 and 280 have front faces 286 and 288, respectively, which are substantially perpendicular to the plane of the removable back cover 270. Tabs 290 and 292 are formed integral with the front faces 286 and 288, respectively, and are substantially parallel with respect to the plane of the removable back cover 270.

The removable back cover 270 may be installed after the MSR 104 has been installed on the display system 100 as discussed previously. One or more tabs 304 (not shown) protrude from the back of the removable back cover 270. The top edge 282 of the removable back cover 270 is tipped towards the display system 100. The tabs 304 are inserted under the groove 258. The removable back cover 270 is then tilted slightly if necessary to position the side edge 300 under the inner surface 146 of the arm member 138. The tabs 290 and 292 are snappingly received by grooves or slots 294 and 296, respectively, in the back cover 110. The slots 294 and 296 are obscured by a cable cover 298, but their position is indicated on FIG. 4.

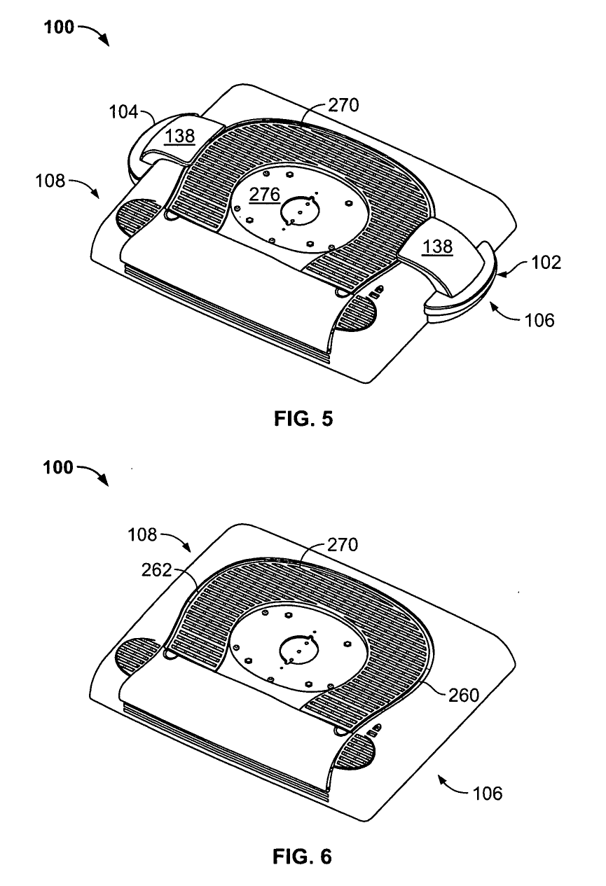

FIG. 5 illustrates the MSR 102 installed on the left side 106 and the MSR 104 installed on the right side 108 of the display system 100 in accordance with an embodiment of the present invention. The removable back cover 270 has also been installed as discussed previously. The arm members 138 slightly overlap the removable back cover 270. The MSRs 102 and 104 are securely fastened to the display system 100 and neither of the cables 114 and 116 is exposed.

FIG. 6 illustrates the display system 100 having the removable back cover 270 installed in accordance with an embodiment of the present invention. Break away plugs 260 and 262 are intact in FIG. 6. If a user wished to install either the MSR 102 or the MSR 104 on the display system 100, the break away plug 260 or 262 on the appropriate side would be removed to provide access for the mount plate 214. As discussed previously, the break away plugs 260 and 262 may be located at different positions than illustrated and additional break away plugs may be provided to allow additional mounting locations.

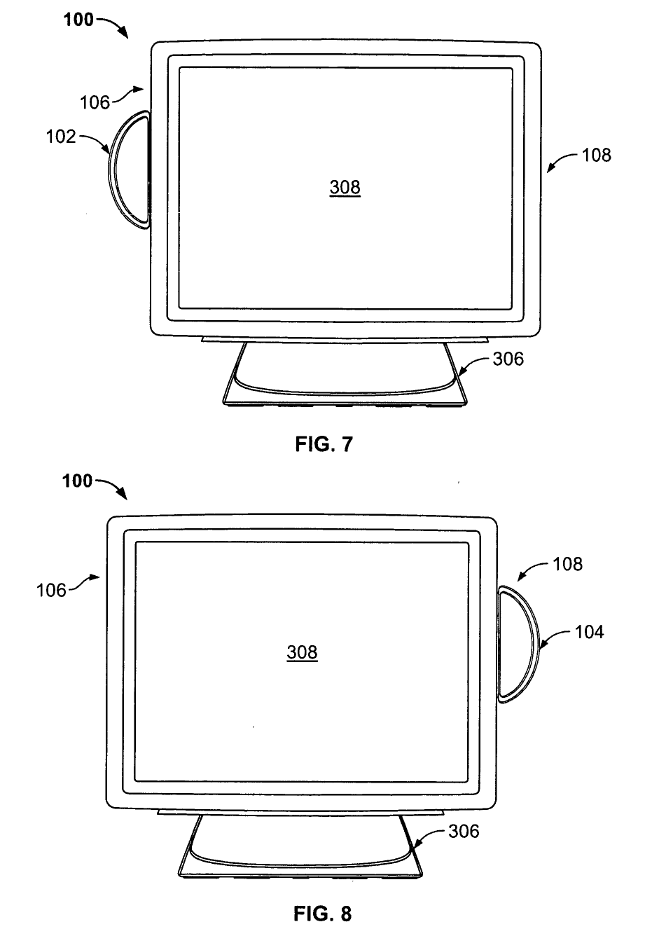

FIG. 7 illustrates a front view of the display system 100 having the MSR 102 mounted on the left side 106 in accordance with an embodiment of the present invention. FIG. 8 illustrates a front view of the display system 100 having the MSR 104 mounted on the right side 108 in accordance with an embodiment of the present invention. The display system 100 has been mounted on a monitor stand 306. It should be understood that the display system 100 may be mounted to structure other than the monitor stand 306, such as a table top or wall.

The display system 100 comprises a display 308 which may also accept input, such as a touchscreen. Being able to mount the MSR 102 and 104 on either the left or right side 106 and 108 of the display system 100 enhances the flexibility for a user. Therefore, the user may easily incorporate the display system 100 into an environment where there may be obstructions such as other equipment, a wall, or desk preventing easy access to the slot 136 for sliding the transaction card on either the left or right sides 106 and 108. The MSRs 102 and 104 are easily removable, allowing replacement and service to be performed on the electronic unit. Alternatively, an MSR 102 and 104 may be easily replaced or reinstalled on an opposite side of the display system 100 or in a different position as discussed previously.

While the invention has been described in terms of various specific embodiments, those skilled in the art will recognize that the invention can be practiced with modification within the spirit and scope of the claims.

What is claimed is:

1. A magnetic stripe reader (MSR) configured to be attached to a display system, comprising:
a housing for at least partially enclosing an electronic unit for reading and decoding a magnetic stripe on a transaction card;
an arm member extending from said housing; and
a mount plate being attachable to said arm member, said mount plate being configured to secure said MSR to the display system.

2. The MSR of claim 1, said mount plate further comprising an interlocking member configured to extend through a back plate of the display system.

3. The MSR of claim 1, said mount plate further comprising an interlocking member configured to extend into a slot in a back side of the display system, said interlocking member extending under an inner surface of the back side to secure said mount plate to the display system.

4. The MSR of claim 1, wherein said mount plate being configured to extend into a cavity in a back side of the display system, the cavity being located beneath a removable back cover.

5. The MSR of claim 1, further comprising a frame being attachable to an inner surface of said arm member, said frame partially enclosing said electronic unit, said frame and mount plate being joined to each other.

6. The MSR of claim 1, further comprising a mounting bracket being attachable to an inner surface of said arm member, said mounting bracket being integral with said mount plate and retaining a cable for interconnecting said electronic unit and the display system between said mounting bracket and said inner surface.

7. The MSR of claim 1, wherein said mount plate being configured to be secured to one of a left side and a right side of the display system.

8. The MSR of claim 1, wherein said housing and said arm member being formed integral with one another.

9. A display system having a magnetic stripe reader (MSR) configured to be mounted to said display system in at least two locations, comprising:
a display system comprising a display for presenting information, said display system having a left side and a right side with respect to said display, said display system further comprising a back plate;
an MSR comprising:
a housing for retaining an electronic unit for reading a magnetic stripe of a transaction card; and
a mount plate being connected to said housing, said mount plate being configured to be attached to said back plate to secure said MSR to said display system.

10. The display system of claim 9, further comprising a removable back cover being snappingly received by said display system, said removable back cover obscuring at least a portion of said back plate.

11. The display system of claim 9, further comprising:
said MSR further comprising an arm member extending from said housing, said arm member being attachable to said mount plate; and
a removable back cover extending between said mount plate and said arm member, said removable back cover obscuring at least a portion of said mount plate.

12. The display system of claim 9, wherein said mount plate being configured to be attachable to said back plate along said left and right sides.

13. The display system of claim 9, further comprising an arm portion joined to said mount plate and extending from said housing, said arm portion being curved to extend from one of said left and right sides to a back side of said display system.

14. The display system of claim 9, said mount plate further comprising an interlocking member configured to extend through said back plate of said display system to secure said mount plate to said display system.

15. A display system having a magnetic stripe reader (MSR) securely attached thereto, comprising:
an MSR comprising:
a housing for retaining an electronic unit for reading a magnetic stripe of a transaction card, said housing having a slot for sliding the transaction card through;
a mount plate being attachable to said housing;
a display system comprising:
a display for displaying information to and accepting input from a user; and
a plate being at least partially obscured by a cover, said plate providing at least one mounting location for attaching said mount plate of said MSR to said display system.

16. The display system of claim 15, wherein said removable cover being configured to obscure said mount plate.

17. The display system of claim 15, further comprising a cable for interconnecting said MSR and said display system, said cable being obscured by at least one of said mount plate and said removable cover.

18. The display system of claim 15, said plate further comprising providing first and second mounting locations for mounting said MSR, said first mounting location being configured to provide access to said slot of said MSR on a left side of said display, said second mounting location being configured to provide access to said slot of said MSR on a right side of said display.

19. The display system of claim 15, said MSR being configured to be attachable to a left side and a right side of said display.

20. The display system of claim 15, wherein said mounting location being configured to retain said MSR along a left side of said display.
